(19) United States
(12) Patent Application Publication
(10) Pub. No.: US 2004/0057831 A1
(43) Pub. Date: Mar. 25, 2004

(54) Ceiling fan

(76) Inventor: Chao-Pao Lin, Taichung (TW)

Correspondence Address: BROWDY AND NEIMARK, P.L.L.C., 624 NINTH STREET, NW, SUITE 300, WASHINGTON, DC, 20001-5303, US

(21) Appl. No.: 10/448,131

(22) Filed: May 30, 2003

(30) Foreign Application Priority Data
Sep. 23, 2002 (TW) 91214987

(51) Int. Cl. F03B 3/12

(52) U.S. Cl. 416/210 R

(57) ABSTRACT

A ceiling fan includes a connecting rod assembly, a motor, a housing, a cover shell, and a vane assembly. The connecting rod assembly includes a fixing seat secured to a ceiling and a connecting rod suspended beneath the fixing seat. The motor is mounted beneath the connecting rod. The housing encases the motor and is rotatable by the motor with respect to the connecting rod assembly. The cover shell is semi-spherical and is secured beneath the housing. The vane assembly is connected with the cover shell and includes a plurality of vanes and vane brackets. Accordingly, the ceiling fan is provided with a preferably centralized mass at its rotation circle to enhance the rotation stability and the whole model design and to reduce the production cost.

### BACKGROUND OF THE INVENTION

1. Field of the Invention

The present invention relates generally to ceiling fans, and more particularly to a ceiling fan which rotating stability is enhanced.

2. Description of the Related Art

As shown in FIG. 1, a conventional ceiling fan 1 is composed of a connecting rod assembly 2, a motor (not shown) mounted at a bottom end of the connecting rod assembly 2, a housing 3, five vanes 5, and five vane brackets 4. Each of the vane brackets 4 is secured to a lower end of the housing 3 at an end thereof, connected with each of the vanes 5 at the other end thereof, and has a curved elongated linking portion 6 at a middle portion thereof. From the above structure, the ceiling fan 1 is provided with a very scattered mass at its rotation circle. While the ceiling fan 1 is in rotation, an air eddy will be generated to cause irregular swing of the ceiling fan 1. If the ceiling fan 1 is rotated in more speed, more irregular swing will be incurred, thereby causing potential risk of harm to the users.

In addition, the vane brackets 4 are made of metal and large-sized so as to cost a lot in production. Although the assembly of the connecting rod 2 or the vane bracket 4 is reinforced, the ceiling fan 1 is still not stable in rotation, especially in high speed, to be unsafe for the users. Moreover, the model design of the conventional ceiling fan 1 needs to be improved.

### SUMMARY OF THE INVENTION

The primary objective of the present invention is to provide a ceiling fan which rotation stability is effectively enhanced.

Another objective of the present invention is to provide a ceiling fan which production cost is reduced.

Still another objective of the present invention is to provide a ceiling fan which model design is well enhanced.

The foregoing objectives of the present invention are attained by the ceiling fan which is composed of a connecting rod assembly, a motor, a housing, a cover shell, and a vane assembly. The connecting rod assembly includes a fixing seat secured to a ceiling and a connecting rod suspended beneath the fixing seat. The motor is mounted beneath the connecting rod. The housing which encases the motor is rotatable by the motor and includes a circular convex portion at a bottom side thereof. The cover shell is semi-spherical and includes a top opening at a top side thereof and a bottom opening at a bottom side thereof for the convex portion of the housing inserted through to enable the cover shell to rotate along with the housing synchronously. The vane assembly is connected with the cover shell and includes a plurality of vanes and vane brackets. Each of the vane brackets has an arm portion at an end thereof connected with the cover shell and kept away from the housing, and a head portion at the other end thereof connected with each of the vanes. Accordingly, the improved ceiling fan is provided with a preferably centralized mass at its rotation circle to enhance the rotation stability and the whole model design.

### BRIEF DESCRIPTION OF THE DRAWINGS

FIG. 1 is a perspective view of a prior art;

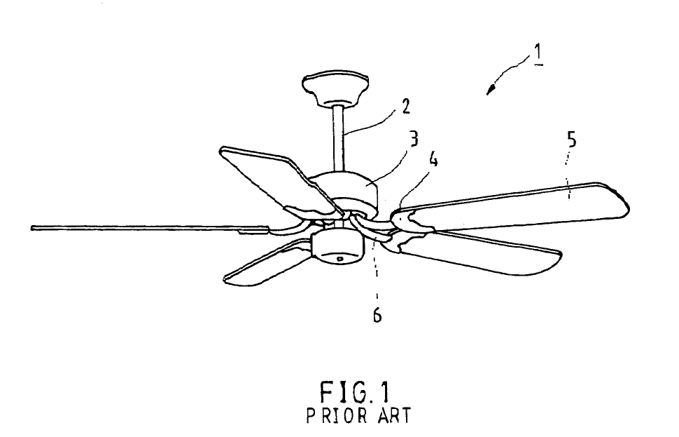

FIG. 2 is a partial exploded view of a first preferred embodiment of the present invention;

FIG. 3 is a sectional view of the first preferred embodiment of the present invention;

FIG. 4 is an exploded view of a second preferred embodiment of the present invention; and

FIG. 5 is a sectional view of the second preferred embodiment of the present invention.

### DETAILED DESCRIPTION OF THE INVENTION

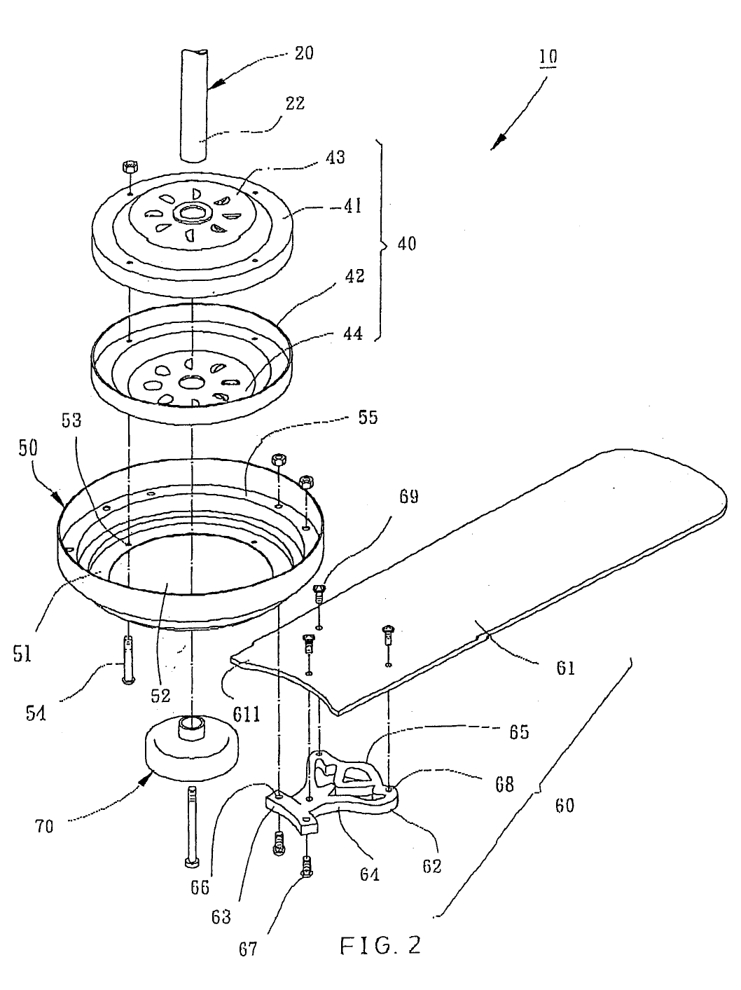

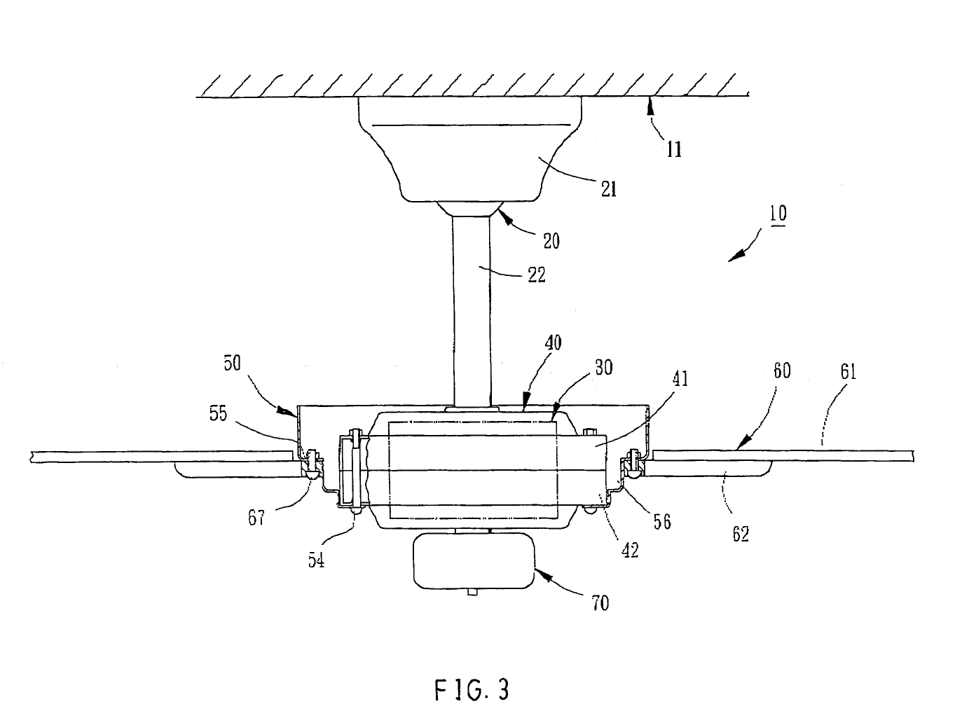

Referring to FIGS. 2-3, an improved ceiling fan 10 of the present invention is composed of a connecting rod assembly 20, a motor 30, a housing 40, a cover shell 50, and a vane assembly 60.

The connecting rod assembly 20 includes a fixing seat 21 securely mounted to a ceiling 11 and a longitudinal connecting rod 22 having a top end securely mounted to and positioned beneath the fixing seat 21.

The motor 30 is mounted to and positioned beneath the connecting rod 22.

The housing 40 includes an upper housing member 41 and a lower housing member 42. The upper and lower housing members 41 and 42, which are substantially semi-spherical, each include a circular opening facing to the other and having the same diameter and a convex portions 43 (44) protruded from a top side of the upper housing member 41 (a bottom side of the lower housing member 42). The upper and lower housing members 41 and 42 correspond to each other to encase the motor 30 and can be driven to rotate by the motor 30 with respect to the connecting rod assembly 20.

The cover shell 50 is substantially semi-spherical, sectionally stepped, and fixedly mounted beneath the housing 40. The cover shell 50 includes a top opening facing upwards at a top side thereof, a bottom opening 52 at a bottom side 51 thereof for the convex portion 44 of the lower housing member 42 inserted through, wherein the top opening is larger than the bottom opening 52 in diameter, a plurality of through holes 53 for bolts 54 inserted through to enable the housing 40 threadedly connected with the cover shell 50 and to further enable the cover shell 50 to rotate along with the housing 40 synchronously, and an annular underside 55 positioned at an outer periphery thereof. A gap 56 is formed between the annular underside 55 and the outer periphery of the cover shell 50.

The vane assembly 60 is disposed on a periphery of the cover shell 50 and is made of five vanes 61 and five vane brackets 62. Each of the vanes 61 is an elongated wooden plate and includes a connecting portion 611 at an end thereof for connecting each of the vane brackets 62 and an arched portion at the other end thereof. Each of the vane brackets 62 is integrally made of metal casting and includes an arm portion 63 at an end thereof, a head portion 65 at the other end thereof, and a neck portion 64 at a middle section thereof, wherein the arm portion 63 has two tapped holes 66 for bolts 67 inserted through to enable the arm portion 63 to be threadedly connected with the annular underside 55 of the cover shell 50. The head portion 63 and the connecting portion 611 respectively have corresponding tapped holes 68 for bolts 69 inserted through to enable the vane bracket 62 to threadedly connect the vanes 61. The neck portion 64 is an elongated shaft for connecting the head portion 65 and the arm portion 63 and has a length ranged between 1 cm and 2 cm.

In operation, by means of the cover shell 50, the gap 56, and the neck portion 64, the ceiling fan 10 is provided with a preferably centralized mass at its rotation circle to be rotated preferably stably. The vane brackets 62 are made of metal, such that the production cost can be effectively reduced by the neck portion 64 having shorter length than the linking portion of the prior art. In addition, the cover shell 50 can be well designed for its appearance to increase the marketing advantage of the present invention. Moreover, the ceiling fan further includes a junction box 70 at a bottom thereof, which has a receiving space for receiving a variety of wires. The junction box is a prior art so as not to be described in detail for the structure and the connection.

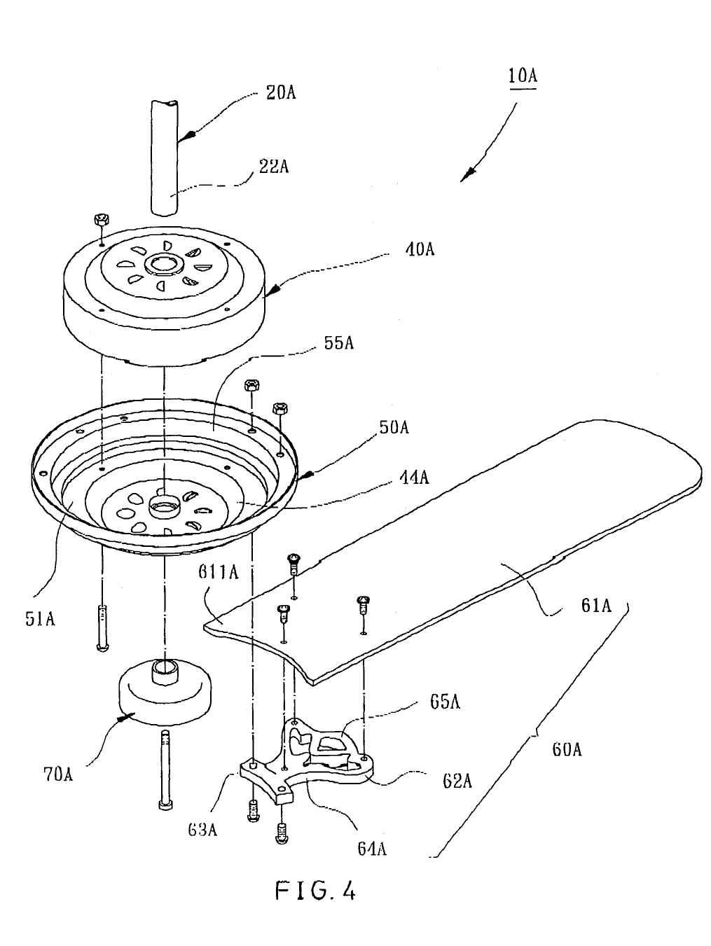

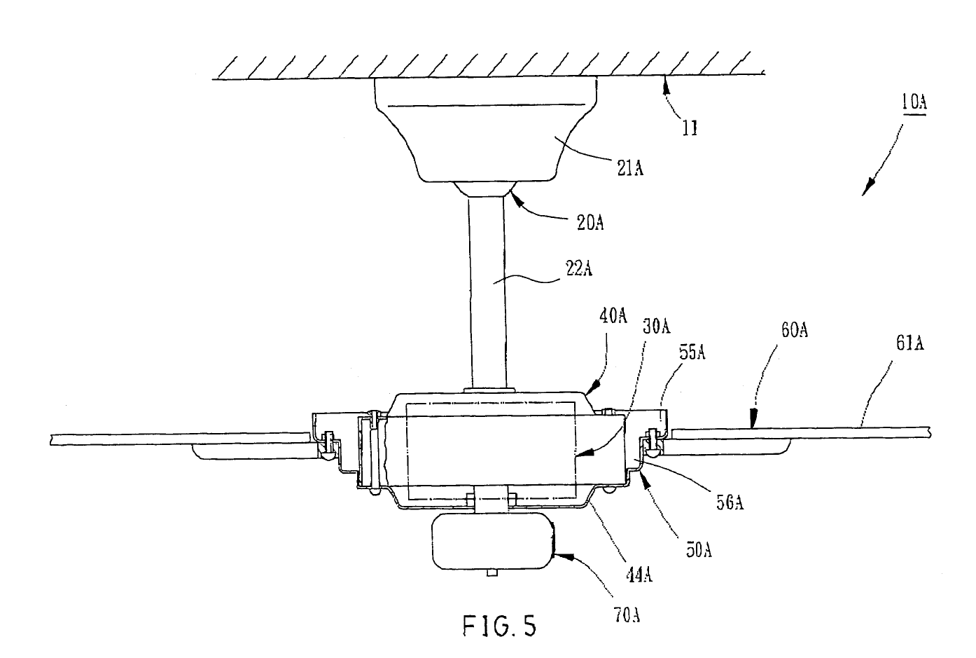

Referring to FIGS. 4-5, the ceiling fan 10A of a second preferred embodiment of the present invention includes a connecting rod assembly 20A, a motor 30A, a housing 40A, a cover shell 50A, and a vane assembly 60A.

The connecting rod assembly 20A includes a fixing seat 21A securely mounted to the ceiling 11 and a connecting rod 22A securely mounted to and positioned beneath the fixing seat 21A.

The motor 30A is mounted to and positioned beneath the connecting rod 22A.

The housing 40A, which has an opening facing downwards, is positioned above and covers the motor 30A and is driven to rotate by the motor 30A.

The cover shell 50A, which is substantially semi-spherical and sectionally stepped, includes an opening facing upwards and larger than the opening of the housing 40A in diameter to receive and connect the housing 40A, thereby enabling the cover shell 50A to rotate synchronously along with the housing 40A. The motor 30 A is mounted between the housing 40A and the cover shell 50A. The cover shell 50A includes a convex portion 44A protruded downwards from a bottom thereof, a through hole running through the center of the convex portion 44A for connecting a junction box 70A, and an annular underside 55A at an outer periphery thereof. The annular underside 55A is distant from an outer periphery of the housing 40A with a gap 56A.

The vane assembly 60A connected to the cover shell 50A includes a plurality of vanes 61A and vane brackets 62A. Each of the vane brackets 62A has an arm portion 63A at an end thereof away from the housing 40A for connecting the cover shell 50A, and a head portion 65A at the other end thereof for connecting each of the vanes 61A.

In conclusion, the present invention provides the improved ceiling fan, which rotation stability is effectively enhanced and which production cost is reduced.

What is claimed is:

1. A ceiling fan for mounting on a ceiling, said ceiling fan comprising:
a connecting rod assembly having a fixing seat secured to said ceiling, and a connecting rod suspended beneath said fixing seat;
a motor mounted beneath said connecting rod;
a housing encasing said motor and driven by said motor to rotate and having a circular convex portion at a bottom side thereof;
a cover shell being semi-spherical, secured to and beneath said housing, and having an opening facing upwards and a through hole formed at a center of a bottom side thereof for said circular convex portion of said housing inserted through,.whereby said cover shell is rotated synchronously along with said housing; and
a vane assembly connected with said cover shell and having a plurality of vane brackets and vanes, each of said vane brackets having an arm portion at an end thereof away from said housing in a distance for connecting said cover shell and a head portion at the other end thereof for connecting each of said vanes.

2. The ceiling fan as defined in claim 1, wherein said housing comprises an upper housing member and a lower housing member, said upper and lower housing members being semi-spherical and each having an opening facing to the other and provided with the same diameter, whereby said two housing members correspond to each other to encase said motor.

3. The ceiling fan as defined in claim 1, wherein said cover shell is sectionally stepped and comprises an annular underside at an outer periphery thereof, said annular underside being distant from an outer periphery of said housing with a gap.

4. A ceiling fan for mounting on a ceiling, said ceiling fan comprising:
a connecting rod assembly having a fixing seat secured to said ceiling and a connecting rod suspended beneath said fixing seat;
a motor mounted beneath said connecting rod;
a housing encasing and positioned above said motor and driven by said motor to rotate;
a cover shell being substantially semi-spherical and having a convex portion protruded downwards from a bottom side thereof, said cover shell corresponding to and connected with said housing, whereby said cover shell is rotated synchronously along with said housing; and
a vane assembly connected with said cover shell and having a plurality of vane brackets and vanes, each of said vane brackets having an arm portion at an end thereof away from said housing in a distance for connecting said cover shell and a head portion at the other end thereof for connecting each of said vanes.

5. The ceiling fan as defined in claim 4, wherein said cover is sectionally stepped and comprises an opening facing upwards and an annular underside at an outer periphery thereof, said annular underside being distant from an outer periphery of said housing with a gap.
